(19) United States
(12) Patent Application Publication
(10) Pub. No.: US 2022/0306535 A1
(43) Pub. Date: Sep. 29, 2022

(54) METHOD OF PRODUCTION OF A MINERAL FOAM FOR FILLING CAVITIES

(71) Applicant: HOLCIM TECHNOLOGY LTD, ZUG (CH)

(72) Inventors: Florent DALAS, HOLDERBANK (CH); Sébastien GEORGES, HOLDERBANK (CH); Cyril MOUNIE, HOLDERBANK (CH); Florent SKAWINSKI, HOLDERBANK (CH)

(21) Appl. No.: 17/639,028

(22) PCT Filed: Aug. 27, 2020
(86) PCT No.: PCT/EP2020/073990

§ 371 Date: Feb. 28, 2022

(30) Foreign Application Priority Data
Aug. 30, 2019 (EP) 19306058.9

(51) Int. Cl. C04B 28/04; C04B 14/28; C04B 22/12; C04B 24/38; C04B 38/02; C04B 40/00

(52) U.S. Cl. CPC C04B 28/04; C04B 14/28; C04B 22/12; C04B 24/383; C04B 38/02; C04B 40/0046; C04B 2103/302

(57) ABSTRACT

A method for the production of a cavity filled with a low-density mineral foam includes (i) preparing a cement slurry including Portland cement; ultrafine particles of which the D50 is from 10 to 600 nm; a water reducing agent; a manganese salt; and water; wherein the mass ratio of manganese salts/Portland cement is below 0.014; (ii) adding to the cement slurry obtained after (i) a gas-forming liquid including a gas-forming agent; and a viscosity-modifying agent which is a polymer chosen among anionic bio-based polymer, amphiphilic bio-based polymer, alkali swellable acrylic polymer and mixture thereof; to obtain a foaming slurry; (iii) filling the cavity with the foaming slurry obtained at (ii); (iv) leaving the foaming slurry to expand within the cavity.

### FIELD OF THE INVENTION

The invention refers to a method for producing a low-density mineral foam of excellent stability. The mineral foam of the present invention is particularly suitable for filling cavities, in particular cavities of complex shapes.

### BACKGROUND OF THE INVENTION

Mineral foam, also named cement foam, combines advantageous properties such as very low specific weight compared to traditional concrete or other building materials.

It comprises a network of bubbles more or less distant from each other that are gas pockets contained in a solid envelope of mineral binder. Due to the pores or empty spaces that it comprises, it is a material that is significantly lighter than traditional concrete.

Mineral foam can be produced by mixing two liquid components, i.e. a cement slurry and a liquid containing a gas-forming agent, to obtain a foaming slurry which expands to form a foamed slurry and then sets and hardens to become said mineral foam. The expansion is the direct consequence of the formation of bubbles upon mixing of the two liquids.

The production of mineral foam involves a step of production of foaming slurry which must be stable. The setting of the liquid foam into solid foam is delicate. The phenomena of destabilization of the foams during setting, such as for example coalescence, Ostwald ripening or drainage must therefore be controlled notably by the production method. These difficulties are exacerbated when the production method is a continuous method wherein the finished product is elaborated in an uninterrupted manner. However, continuous production methods are best suited to an industrial environment and are recommended in plants or on work sites.

One of the difficulties in the continuous production of mineral foams in an industrial context is thus to produce a stable foam offsetting these destabilisation phenomena.

Patent application WO 2019/092090 discloses a mineral foam prepared continuously by mixing a gas-forming liquid comprising a viscosity-modifying agent and a cement slurry in the presence of manganese salt as catalyst precursor. The mineral foam disclosed in that application adheres to the surface onto which it is applied, preventing it from sliding when applied to a vertical substrate.

Such a mineral foam is perfectly suitable for coating surface but is less performant for filling a cavity, in particular a complex cavity, because it may not fill the whole volume of the cavity, especially interstice or gap or unevenness.

The present invention aims to provide a method for the production of mineral foam suitable for filling any cavity, in particular filling a complex cavity. A complex cavity is a cavity with a complex geometry and/or a cavity having singular point(s). The complex geometry or singular point may notably result from variation of inner thickness of the cavity, variation of dimensions of the cavity, surface ruggedness of the cavity, and combinations thereof. As examples of cavities, one can recite: an o-ring; double envelopes in thermally insulated residential and industrial devices; cavity within the insulating part of a water boiler; complex cavities in construction systems, such as double masonry wall or the space between two 3D-printed walls, pre-walls, or cavities around a window frame or motorised shutters; or cavity or rugged surface within a 3D-printed element. The aim is to provide a mineral foam suitable for filing the whole volume of any cavity, including complex cavity.

The present invention also aims to provide mineral foams that have excellent stability properties as well as excellent thermal properties, and notably a very low thermal conductivity.

Following the present invention, upon mixing of the cement slurry and gas-forming liquid, the gas-forming agent starts to react to form bubbles in the slurry. Due to the specific features of the cement slurry and gas-forming liquid used in the present invention, the bubbles that form in the foaming slurry do not coalesce and remain homogeneously distributed within the resulting foamed slurry. The immediate result is a foaming slurry that remains stable until the cement sets and hardens, i.e. in which the air bubbles are homogeneously distributed in the volume of the cement foam. The final result is a low-density mineral foam, suitable for example for thermally insulating buildings and construction elements.

It was surprisingly found that by using a selected range of mass ratios of manganese salts to cement, the foam generation and the foaming slurry expansion time are improved for the desired application.

Therefore, the method according to the invention achieves the following advantages:
the mineral foam can be produced in a continuous manner;
the foaming slurry can fill any cavity, including complex cavity;
the final density (after setting of the cement and drying of the foam) of the mineral foam is low, i.e. comprised between 70 and 180 kg/m³.

The typical singularities in the complex cavity can be the tubes for electrical or plumbing tubes, switches, or the regular unevenness of 3D printed walls, formed by depositing successive ribbons of construction material onto each other.

### SUMMARY OF THE INVENTION

The invention refers to a method for filling a cavity with a low-density mineral foam comprising the following steps:
(i) preparing a cement slurry comprising:
   Portland cement;
   ultrafine particles of which the D50 is comprised from 10 to 600 nm;
   a water reducing agent;
   manganese salts; and
   water;
   wherein the mass ratio of manganese salts/Portland cement is below 0.014
(ii) adding to the cement slurry obtained after step (i) a gas-forming liquid comprising:
   a gas-forming agent; and
   a viscosity-modifying agent which is a polymer chosen among anionic bio-based polymer, amphiphilic bio-based polymer, alkali swellable acrylic polymer and mixture thereof;
to obtain a foaming slurry;
(iii) filling a cavity with the foaming slurry obtained at step (ii);
(iv) leaving the foaming slurry to expand within the cavity.

The method can be continuous. By continuous, we mean the continuous mixing of the liquid components mentioned above, i.e. the cement slurry and the liquid containing the gas-forming agent.

Preferably, the mass ratio of manganese salts/Portland cement is below 0.013, advantageously below 0.0125.

Preferably, the mineral foam has a density in the dry state from 50 to 180 kg/m³, more preferentially from 60 to 170 kg /m³, even more preferentially from 70 to 150 kg/m³.

Advantageously, the Portland cement has a Blaine specific surface area above 5000 cm²/g.

In particular, the gas-forming agent comprised in the gas-forming liquid added in step (ii) is in a concentration of less than 15 wt. % of the weight of the gas-forming liquid, preferably less than 8 wt. %.

Preferably, the gas-forming agent comprised in the gas-forming liquid added in step (ii) is a solution of hydrogen peroxide, a solution of peroxomonosulphuric acid, a solution of peroxodisulfphuric acid, a solution of alkaline peroxides, a solution of alkaline earth peroxides, a solution of organic peroxide, a suspension of particles of aluminium or mixtures thereof, preferably it is a solution of hydrogen peroxide.

In particular, the viscosity-modifying agent comprised in the gas-forming liquid added in step (ii) is an amphiphilic bio-based polymer, preferably chosen among methyl cellulose, methylhydroxyethyl cellulose and hydroxypropylmethyl cellulose.

Advantageously, the cement slurry of step (i) further comprises a mineral addition of which the particles have a D50 comprised from 0.1 to 4 mm.

Preferably, the cement slurry of step (i) further comprises fibres.

Advantageously, the cement slurry of step (i) is obtained by first blending a premix of cement, ultrafine particles and optionally mineral addition, and then adding the water reducing agent, manganese salts and water. In yet another embodiment, the water reducing agent is in powder form and included in the premix.

Alternatively, the manganese salts can be blended with the premix of cement, ultrafine particles and optionally mineral addition before water and a water reducing agent are added. In yet another embodiment, the water reducing agent is in powder form and included in the premix.

Preferably, the cavity of step (iii) is a cavity with complex geometry or singular point resulting from variation of inner thickness of the cavity, variation of dimensions of the cavity, surface ruggedness of the cavity, and combinations thereof. Preferably the cavity is a cavity in an element of a building or a construction, including 3D printed construction. The invention also refers to a construction whose at least one cavity is filled by the method of the invention.

The construction is especially a double masonry wall, a 3D-printed construction, such as a 3D-wall, cavities around a window frame or motorised shutters, a rugged surface.

The invention further refers to the use of said construction whose at least one cavity is filled mineral foam by the method of the invention for insulation, in particular for thermal or phonic insulation.

Alternatively, the cavity of step (iii) is a cavity in a residential or industrial device, in particular a jacketed device, such as double envelopes in thermally insulated residential and industrial devices, insulating part of a water boiler.

The invention further refers to a method for insulating a device, in particular for thermal or phonic insulation, by filling at least one cavity of the device or of the jacket of the device with a low-density mineral foam by the method of the invention.

### BRIEF DESCRIPTION OF THE FIGURES

FIG. 1 is a diagram illustrating the principle of measuring a contact angle between a drop of water and a surface.

FIG. 2 is a diagram illustrating the methodology for measuring the foaming slurry expansion time:
2A: in a cylinder 3 comprising cement slurry 2 pour the gas forming liquid 1 under agitation 31
2B: at the end of the agitation (the agitation means 31 is removed), starts the chronometer. The foaming slurry 4 starts to expand
2C: the foaming slurry 4 reaches the top of the cylinder
2D: the foaming slurry 4 finishes its expansion outside the cylinder

FIG. 3 is a diagram illustrating the prototype having a box-form. The box comprises three columns: left-column (5L), middle column (5M) and right-column (5R). The middle column is separated from the left and right columns by movable walls which can be opened (by lifting them) to allow the foaming slurry, poured in the middle column 6 to reach the left and right columns. The gap width 51 can be changed to vary the complexity of the pouring.

FIG. 4 is pictures of the prototype box poured with a foaming slurry of the invention (6B, gap width 51=6 cm, 6D, gap width 51=2 cm) or with control foaming slurry (6A, gap width 51=6 cm, 6C, gap width 51=2 cm).

### DETAILED DESCRIPTION OF EMBODIMENTS OF THE INVENTION

In the present invention, the term foaming slurry refers to the mixture of cement slurry and gas-forming liquid, in which the gas-forming agent reacts to form bubbles, and prior to the setting and hardening of the cement. The term foamed slurry refers to the mixture of cement slurry and gas-forming liquid, once all the gas-forming agent has reacted to form bubbles, and prior to the setting and hardening of the cement.

In the present invention, the term mineral foam describes the foamed slurry once the cement has set and hardened.

### Cement Slurry of Step (i)

The cement slurry of the present invention comprises Portland cement, ultrafine particles of which the D50 is comprised from 10 to 600 nm, a water reducing agent, manganese salts and water. It can also optionally contain fibres and/or mineral additions.

The cement suitable for producing a mineral foam according to the present invention is a Portland cement.

Portland cement is a mixture of ground Portland clinker, a source of calcium sulfate such as gypsum or anhydrite, optionally mineral components and minor additions, as described in the cement standard NF EN 197-1 published in April 2012.

Preferably, said ground clinker has the following mineralogical composition, % in weight compared to the total weight of the clinker:
50 to 80 wt. % of C3S (alite),
4 to 40 wt. % of C2S (belite),
0 to 20% wt. of C4AF (ferrite or aluminoferrite or brownmillerite),
0 to 15% wt. of C3A (aluminate),
and secondary mineral components.

The mineralogical components of the clinker are noted according to the common cement industry notation:
C represents CaO,
A represents Al₂O₃,
F represents Fe₂O₃, and
S represents SiO₂.

All cement types described in the cement standard NF EN 197-1 published in April 2012 (CEM I, CEM II, CEM III, CEM IV, CEM V) may be used for the preparation of the cement slurry. Also the cement may be a mixture of a CEM I and mineral additions, the mixing being done just prior or during the preparation of the cement slurry.

Preferentially, the cement suitable in the present invention is a CEM I, as described in the cement standard NF EN 197-1 published in April 2012.

Portland cement CEM I comprises at least 95 wt. % of a ground clinker such as described above compared to the total weight of cement.

Advantageously, the cement slurry of the invention comprises from 50 to 60 wt. % of Portland cement compared to the total weight of cement slurry.

In one embodiment of the present invention, the Portland cement is characterized by a Blaine surface of at least 5000 cm²/g. Preferably, the Portland cement is characterized by a Blaine surface comprised from 5000 to 9000 cm²/g.

In particular, the Portland cement is characterized by a Blaine surface of at least 5000 to 8000 cm²/g. Preferably, the Portland cement is characterized by a Blaine surface comprised from 5500 to 8000 cm²/g.

In the present invention, fine Portland cements having a Blaine value of at least 5000 cm²/g can be used without degrading the foam properties, while significantly reducing the water demand of the slurry. This invention enables to have a flowable and pumpable cement slurry without requiring the addition of high amounts of water. This has also the advantage of enabling a reduction of the concentration of gas forming agent in the gas forming liquid. The Portland cement fineness was also demonstrated to reduce the bubble size.

Preferably, the cement used for slurry has an initial setting time comprised between 80 and 150 minutes, and a final setting time between 150 and 250 minutes at room temperature, also when additional admixtures, including accelerators or retarders, are added. The setting time is measured according to the standard NF EN 196-3 published in January 2009.

The cement slurry of the present invention comprises ultrafine particles of which D50 is comprised from 10 to 600 nm.

Advantageously, the cement slurry of the invention comprises from 0.5 to 10 wt. %, preferably from 1 to 7 wt. % of ultrafine particles compared to the total weight of cement slurry.

Advantageously, the ultrafine particles in the cement slurry of the present invention have a liquid-solid contact angle comprised from 30° to 140°, preferably comprised from 40° to 130°, even more preferentially from 70° to 130°.

This contact angle is also called wetting angle. The expression “contact angle” or “wetting angle” is taken to mean the angle formed between a liquid/vapour interface and a solid surface. It is the angle formed between the interface of a liquid and the solid surface on which the liquid is deposited. It is generally considered that a surface, such as a wall, is hydrophilic when the static contact angle of a drop of water arranged on the surface is less than around 30 degrees and that the surface, such as a wall, is hydrophobic at variable hydrophobic levels when the static contact angle of a drop of distilled water arranged on the surface is greater than around 30 degrees and less than around 140°. The surface, such as a wall, is designated superhydrophobic when the static contact angle of a drop of distilled water arranged on the surface is greater than around 140 degrees. To produce a foam from the method according to the invention, it could be desirable that the ultrafine particles of the mixture of step (i) are not superhydrophobic, that is to say do not have a contact angle strictly greater than 140°.

Preferably, the ultrafine particles of the cement slurry of the invention are partially rendered hydrophobic, for example by a stearic acid. It is also possible to speak of functionalization. Preferably, the ultrafine particles of the cement slurry of the invention are not hydrophilic.

The ultrafine particles suitable for the cement slurry of the invention have a D50 comprised from 10 to 600 nm, preferably comprised from 20 to 500 nm, more preferentially comprised from 30 to 200 nm.

The D50, also noted Dᵥ50, corresponds to the 50^{th} percentile of the volume distribution of the size of particles, that is to say that 50% of the volume is constituted of particles of which the size is less than the D50 and 50% of size greater than the D50. The D50 can be measured by a laser particle size method described below in the detailed description of embodiments of the invention section.

It may be noted that the ultrafine particles generally comprise elementary particles having a diameter comprised from 10 to 50 nm. These elementary particles may agglomerate to form agglomerated particles having a diameter from 40 nm to 150 nm. These agglomerated particles may agglomerate to form aggregates having a diameter from 100 nm to 600 nm. The ultrafine particles suitable for the cement slurry of the invention may come from one or more materials selected from calcareous powders, precipitated calcium carbonates, natural and artificial pozzolans, pumice stones, ground fly ashes, hydrated silica, in particular the products described in the document FR 2708592, and mixtures thereof.

The cement slurry of the present invention comprises a water reducing agent.

A water reducing agent contains a polymer and other chemicals and that enables the reduction by around 10 to 15% by weight the quantity of mixing water for a given slurry workability and rheology. As an example of water reducing agent may be cited lignosulphonates, hydroxycarboxylic acids, carbohydrates, and other specific organic compounds, such as for example glycerol, polyvinyl alcohol, sodium alumino-methyl siliconate, sulphanilic acid and casein (see Concrete Admixtures Handbook, Properties Science and Technology, V.S. Ramachandran, Noyes Publications, 1984).

Plasticizers are the first generation of water reducing agents. The amount of plasticizer generally depends on the cement reactivity. The lower its reactivity is, the lower amount of plasticizer is needed.

Superplasticizers belong to the new generation of water reducing agents and make it possible to reduce by around 30% by weight the quantity of mixing water for a given workability time. As an example of superplasticizer, it is possible to cite superplasticizers of PCP type that do not contain any antifoaming agent. The term “PCP” or “polycarboxylate polyoxide” is taken to mean according to the present invention a copolymer of acrylic acids or methacrylic acids; and their esters of poly(ethylene oxide) (POE). The amount of superplasticizer generally depends on the cement reactivity. The lower its reactivity is, the lower amount of superplasticizer is needed.

Preferably, the cement slurry of the present invention comprises from 0.2 to 2.0 wt. %, more preferentially from 0.5 to 1.5 wt. %, of a water reducing agent compared to the total weight of the Portland cement.

When the water reducing agent is used in solution, the quantity is expressed in active ingredient in the solution.

The water reducing agent can be present in a liquid solution. The solid content of water reducing agents is typically comprised between 15% and 45%.

The water reducing agent can alternatively be in powder form.

According to an alternative embodiment of the invention, the cement slurry or the mixture obtained after step (ii) of the present invention does not comprise an antifoaming agent, or any agent having the property of destabilizing air bubbles dispersed in a liquid. Some commercially available superplasticizers may contain antifoaming agents and consequently these superplasticizers would not be suitable according to the invention.

According to an alternative embodiment of the invention, the cement slurry according to the invention does not comprise a gas-forming agent.

According to an alternative embodiment of the invention, the cement slurry according to the invention does not comprise a viscosity-modifying agent.

The mixture of step (i) of the method according to the invention could comprise a retarding agent, an accelerating agent or any other as defined in the standard NF EN 934-2 of September 2002.

The cement slurry of the present invention comprises manganese salts as catalyst precursors. Manganese salts are believed to be optimal for the kinetics of the formation of gas bubbles once the cement slurry and gas-forming liquid are mixed together. The preferred manganese salt used for this invention is manganese chloride, MnCl₂.

It was surprisingly found that when manganese salts are used, in a specific manganese salts/Portland cement mass ratio, the rheology of the foaming slurry and of the foamed slurry is suitable for filling cavities. In particular the foaming slurry expansion is increased, leaving sufficient time to the foaming slurry to fill space.

The mass ratio of manganese salts/Portland cement is below 0.014, advantageously below 0.013, more advantageously below 0.0125, even more advantageously below to 0.0115. The mass ratio of manganese salts/Portland cement is strictly above 0, advantageously above 0.0005, more advantageously above 0.0010, even more advantageously above 0.0015, even more advantageously above 0.0025.

The cement slurry of the invention comprises water.

The total water/cement weight ratio of the cement slurry of the invention is from 0.2 to 2.5 preferably, from 0.3 to 1.5, more preferentially from 0.3 to 1. This total water/cement ratio is defined as being the ratio by weight of the water (E) in the slurry over the sum of the weight cement, ultrafine particles and optionally mineral additions in the slurry.

Advantageously, the cement slurry of the present invention further comprises fibres. They allow reducing the issues of both delamination and cracking of the mineral foam. Preferably, the fibres are polypropylene fibres that have a length of 6 mm or 12 mm, and a diameter of 18 μm.

More preferably, the fibres have a length of 6 mm and diameter of 18 μm as they limit the formation of lumps of fibres while pumping the cement slurry and the foamed slurry.

Advantageously, the amount of fibres is between 0.2 wt. % and 2 wt. % by weight of cement, preferentially between 0.2 wt. % and 1 wt. %.

According to an alternative embodiment, the cement slurry of the present invention further comprises a mineral addition such as pozzolan, slag, calcium carbonate, fly ash, sand or mixtures thereof, and of which the particles have a D50 comprised from 0.1 μm to 4 mm. Preferably, the cement slurry of the present invention may comprise from 5 to 50 wt. % of mineral additions, preferably from 10 to 40 wt. %, even more preferably from 10 to 30 wt. %, compared to the total weight of the cement slurry.

The mineral additions suitable for the cement slurry of the present invention are preferably selected from calcium carbonate, silica, ground glass, solid or hollow glass beads, glass granules, expanded glass powders, silica aerogels, silica fumes, slags, ground sedimentary silica sands, fly ashes or pozzolanic materials or mixtures thereof.

Preferably the D50 of the particles of mineral additions suitable for the cement slurry of the present invention is comprised from 0.1 to 500 μm, for example from 0.1 to 250 μm, preferably from 0.2 to 500 μm, preferably from 0.25 to 500 μm. The D50 of the mineral particles is preferably from 0.1 to 150 μm, more preferentially from 0.1 to 100 μm, preferably from 0.2 to 150 μm, preferably from 0.25 to 150 μm.

The mineral additions suitable for the cement slurry of the present invention may be pozzolanic materials (for example as defined in the European standard NF EN 197-1 of April 2012 paragraph 5.2.3), silica fumes (for example such as defined in the European standard NF EN 197-1 of April 2012 paragraph 5.2.7), slags (for example as defined in the European standard NF EN 197-1 of April 2012), materials containing calcium carbonate, for example calcareous materials (for example as defined in the European standard NF EN 197-1 paragraph 5.2.6), siliceous additions (for example as defined in the standard “Concrete NF P 18-509”), fly ashes (for example those as described in the European standard NF EN 197-1 of April 2012 paragraph 5.2.4) or mixtures thereof.

A fly ash is generally a powdery particle comprised in the fumes from coal-fired thermal power stations. It is generally recovered by electrostatic or mechanical precipitation. The chemical composition of a fly ash mainly depends on the chemical composition of the coal burned and of the method used in the power plant from which it comes. The same is true for its mineralogical composition. The fly ashes used according to the invention may be of siliceous or calcic nature.

Slags are generally obtained by rapid cooling of the molten slag coming from the melting of iron ore in a blast furnace. Slags suitable for the mixture of step (i) of the method according to the invention may be selected from granulated blast furnace slags according to the European standard NF EN 197-1 of February 2001 paragraph 5.2.2.

Silica fumes may be a material obtained by reduction of high purity quartz by carbon in electric arc furnaces used for the production of silica and ferrosilica alloys. Silica fumes are generally formed of spherical particles comprising at least 85% by weight of amorphous silica.

Preferably, the silica fumes suitable for the cement slurry of the present invention may be selected from silica fumes according to the European standard NF EN 197-1 of April 2012 paragraph 5.2.7.

Pozzolanic materials may be natural siliceous or silico-aluminous substances, or a combination thereof. Among pozzolanic materials may be cited natural pozzolans, which are in general materials of volcanic origin or sedimentary rocks, and natural calcinated pozzolans, which are materials of volcanic origin, clays, schists or sedimentary rocks, thermally active.

Preferably, the pozzolanic materials suitable for the cement slurry of the present invention may be selected from pozzolanic materials according to the European standard NF EN 197-1 of April 2012 paragraph 5.2.3.

Preferably, the mineral additions suitable for the cement slurry of the present invention may be calcareous powders and/or slags and/or fly ashes and/or silica fumes. Preferably, the mineral additions are calcareous powders and/or slags.

Other mineral additions suitable for the cement slurry of the present invention are calcareous, siliceous or silico-calcareous powders, or mixtures thereof.

Advantageously, the cement slurry of the present invention has a yield stress between 20 and 80 Pa.

In an embodiment, the cement slurry is prepared by first blending a premix of cement, ultrafine particles and optionally mineral additions comprised in the cement slurry of the invention. Said premix is constituted of all the solid constituents except the fibres of the cement slurry of the invention. Said premix can further contain the water reducing agent when this later is in powder form. This step is highly beneficial to the properties of the mineral foam, as it enables to reduce the preparation time of the mineral foam, and also reduces the water demand of the cement slurry.

The cement slurry is then obtained by adding the premix to a solution of manganese salts in water, and optionally adding subsequently the fibres. The solution can further comprise the water reducing agent when this later is in liquid form.

Preferably, in step (i), the cement slurry is continuously stirred to avoid any deposition from occurring.

Alternatively, the manganese salts can be blended with the premix of cement, ultrafine particles and optionally mineral addition before water and a water reducing agent are added. Said premix is constituted of all the solid constituents except the fibres of the cement slurry of the invention. Said premix can further contain the water reducing agent when this later is in powder form. The cement slurry is then obtained by adding the premix to a water solution, and optionally adding subsequently the fibres. The solution can further comprise the water reducing agent when this later is in liquid form.

Preferably, in step (i), the cement slurry is continuously stirred to avoid any deposition from occurring.

### The Gas-Forming Liquid of Step (ii)

The gas-forming liquid of the present invention comprises a gas forming agent and a viscosity modifying agent which is a polymer chosen among anionic bio-based polymer, amphiphilic bio-based polymer and alkali swellable acrylic polymer or mixture thereof.

Advantageously, the gas-forming agent comprised in the gas-forming liquid added in step (ii) is in a concentration of less than 15 wt. % of the weight of the gas-forming liquid, preferably less than 8 wt. %. Advantageously, the gas-forming agent comprised in the gas-forming liquid added in step (ii) is in a concentration of more than 5 wt. % of the weight of the gas-forming liquid.

Advantageously, the gas-forming agent is hydrogen peroxide, peroxomonosulphuric acid, peroxodisulfphuric acid, alkaline peroxides, alkaline earth peroxides, organic peroxide, particles of aluminium or mixtures thereof.

Preferentially, the gas-forming agent is hydrogen peroxide.

In particular, the gas forming agent is diluted in water. When hydrogen peroxide is used, its concentration is comprised between 5 to 40 wt. %.

In a preferred embodiment of the present invention, the concentration of hydrogen peroxide is comprised between 5 and 15 wt. %, more preferably between 5 and 8 wt. % of the total weight of gas-forming liquid. More preferentially, the concentration of hydrogen peroxide is below 8 wt. % compared to the total weight of gas-forming liquid.

It was found that the use of low hydrogen peroxide concentrations was beneficial to reduce the average bubble size. Using a low concentration of hydrogen peroxide, which is an aggressive chemical oxidizer, is also beneficial for the safety of the people working to implement the present invention.

The gas-forming liquid of the invention comprises a viscosity modifying agent.

In particular, the viscosity modifying agent is a water-soluble polymer.

Preferably, the gas-forming liquid of the present invention comprises from 0.01 to 0.10 wt. % of viscosity modifying agent compared to the weight of gas-forming liquid.

The viscosity modifying agent added to the gas-forming liquid is an organic molecule chosen among anionic bio-based polymer, amphiphilic bio-based polymer and alkali swellable acrylic polymer or mixture thereof.

Anionic bio-based polymers are anionic polymers that contain carbon originating from a renewable plant source. In particular anionic bio-based polymers suitable for the gas-forming liquid of the present invention are anionic polymers derived from cellulose, starch or alginate. More particularly, anionic CarboxyMethyl Cellulose, CarboxyMethyl Starch or Alginate are anionic bio-based polymers suitable for the gas-forming liquid of the present invention.

Amphiphilic bio-based polymers are amphiphilic polymers that contain carbon originating from a renewable plant source. In particular, amphiphilic bio-based polymers suitable for the gas-forming liquid of the present invention are amphiphilic polymers derived from cellulose. Methyl Cellulose, MethylHydroxyEthyl Cellulose or HydroxyPropylMethyl Cellulose are amphiphilic bio-based polymers suitable for the gas-forming liquid of the present invention.

Alkali Swellable Acrylic polymers are copolymers of (meth)acrylic acid with a non-water-soluble ester of said acid.

Preferably, the viscosity modifying agent is an amphiphilic bio-based polymer. More preferably the viscosity modifying agent is an amphiphilic polymer derived from cellulose. Even more preferably the viscosity modifying agent is chosen among Methyl Cellulose, MethylHydroxyEthyl Cellulose, HydroxyPropylMethyl Cellulose and mixture thereof.

When compared to hydrophilic polymers, these polymers are amphiphilic and can then adsorb onto the surface of the bubbles of the foamed slurry.

By mixing the viscosity-modifying agent and gas-forming agent beforehand, the viscosity-modifying agent is then directly in the vicinity of the nucleating bubbles, stabilizing them rapidly and effectively.

The mixture of step (ii) of the method according to the invention could comprise a retarding agent, an accelerator or any other admixture as defined the European standard NF EN 934-2 of September 2002.

Step (ii) can be performed continuously or discontinuously, preferably continuously.

The mass ratio of cement slurry to gas forming agent is advantageously between 1.2 and 4.5, preferentially between 2.0 and 4.0.

In a continuous method, the ratio between the flow rate of cement slurry and gas forming agent is advantageously between 2.0 and 4.0, preferentially between 2.5 and 3.5.

The wet density of the foamed slurry of the invention in the fresh state after expansion is comprised between 80 and 190 kg/m³.

### Step (iii): Cavity Filling

The cavity of step (iii) is any cavity, including complex cavity. The cavity may be of different natures and different shapes. A complex cavity is a cavity with a complex geometry and/or a cavity having singular point(s). The complex geometry or singular point may notably result from variation of inner thickness of the cavity, variation of dimensions of the cavity, surface ruggedness of the cavity, and combinations thereof.

The cavity can be open or closed. The cavity is preferably open. In case the cavity is closed, at least one opening is created to fill the mineral foam within the cavity and let air through.

It is understood that the present process is relevant for construction technical field, in particular building or other masonry construction. The construction technical field includes precast. The present process is also relevant for residential or industrial device, in particular a jacketed device, such as double envelopes in thermally insulated residential and industrial devices such as water boilers.

The cavity will thus be a cavity which can be found in this technical field, and especially a cavity in a construction or in a building. The process is particularly relevant for:
constructions such as double masonry wall, pre-walls, cavities around a window frame or motorised shutters;
3D-printed construction, such as a 3D-wall or any 3D-element of construction;
building blocks including terra cotta blocks and cellular concrete blocks;
jacketed device, such as double envelopes in thermally insulated devices, insulating part of a water boiler.

In the present invention, the term masonry refers to constructions involving materials such as concrete, clay, stone or rock, plasterboard, terracotta, cardboard sheet, untreated wood, any other material used in building, as well as mixture thereof.

The construction preferably comprises at least one framework or structural element. This framework may be made of concrete, metal, wood, plastic or composite material or synthetic material.

Of course, the construction element may have a plurality of cavities.

The cavity can be an empty or hollow space of a building, a wall, a partition, a window frame, a masonry block for example a breeze-block, a brick, of a floor or of a ceiling.

The cavity can be an empty or hollow space in a 3D printed construction, notably in a 3D printed wall, or a rugged surface in a 3D-printed element.

The cavity can be an empty or hollow space in a jacketed device, such as double envelopes in thermally insulated devices, cavity within insulating part of a water boiler. Here again a plurality of cavities can be present.

The typical singularities in the cavity can be one or many of the following examples: the tubes for electrical, the plumbing tubes, attachment point for motorised shutters, switches, the regular unevenness of 3D printed walls, rugged surface. In particular, 3D printed constructions, such as 3D printed walls, are formed by depositing successive ribbons of construction material onto each other. Such a method leads to a construction which may contain one or many cavities of irregular shape.

The terms “3D printed” refers to a three-dimensional object built from a computer-aided design (CAD) model, usually by successively adding material layer by layer. Thus, the 3D printed constructions are manufactured by additive manufacturing.

The filling can be performed by any adapted way, such as injection, including injection under pressure, of the foaming slurry within the cavity or depositing one or many layer(s) of foaming slurry into the cavity. A mobile robotic arm can be used to deposit layers of foaming slurry.

After steps (iii) and (iv) of the process of the invention, the volume of unfilled part in the cavity is advantageously less than 50% of the volume of the cavity, advantageously less than 30%, more advantageously less than 25%, more advantageously less than 20%, more advantageously less than 10%, more advantageously less than 5%, it is even possible to fill the whole volume of the cavity.

The surface forming the cavity may be treated before filling with the foaming slurry. The treatment could for example consist in one or more spraying of water to wet the surface, or the treatment could consist in the deposition of bonding primers, or any other solution of physical or chemical nature making it possible to accelerate or slow the setting of the cement at the interface between the surface forming the cavity and the foaming slurry, or to enable better long term adhesion of the foam on the surface forming the cavity or to increase the roughness of the surface forming the cavity.

The mineral foam obtained by the method of the invention shows specific properties.

Preferably, the mineral foam has a density in the dry state from 50 to 180 kg/m³, more preferentially from 60 to 170 kg /m³, even more preferentially from 70 to 150 kg/m³. It may be noted that the density of the foamed slurry, i.e. in the fresh state (wet density), differs from the density of the mineral foam in the dry state, that is to say after setting and drying (density of hardened material). The density of the foamed slurry in the fresh state is always greater than the density of the foam in the dry state.

The invention has the benefit of providing a mineral foam with considerable lightness, and notably a very low-density.

Additionally, the mineral foam obtained with the method of the invention has excellent stability properties. Notably the bubbles that compose the mineral foam in the fresh state are little degraded after pouring into the cavity.

### The Construction Filled with Mineral Foam

The invention also relates to a construction, such as one disclosed above, whose at least one cavity is filled by the method of the invention.

The construction can be a building, a wall, a partition, a window frame, a masonry block for example a breeze-block, a brick, of a floor or of a ceiling.

The construction can be a 3D printed construction, notably a 3D printed wall, or a rugged surface in a 3D-printed element.

### The Device Filled with Mineral Foam

The invention also relates to a device, such as one disclosed above, whose at least one cavity is filled by the method of the invention.

The device can be jacketed device, such as double envelopes in thermally insulated devices or insulating part of a water boiler.

The invention thus also refers to a method for filling at least one cavity of a construction or of a device, especially of the jacket in a jacketed device, with a low-density mineral foam comprising the following steps:
(i) preparing a cement slurry comprising:
   Portland cement;
   ultrafine particles of which the D50 is comprised from 10 to 600 nm;
   a water reducing agent;
   manganese salts; and
   water;
   wherein the mass ratio of manganese salts/Portland cement is below 0.014
(ii) adding to the cement slurry obtained after step (i) a gas-forming liquid comprising:
   a gas-forming agent; and
a viscosity-modifying agent which is a polymer chosen among anionic bio-based polymer, amphiphilic bio-based polymer, alkali swellable acrylic polymer and mixture thereof;
to obtain a foaming slurry;
(iii) filling at least one cavity of a construction or of a device with the foaming slurry obtained at step (ii);
(iv) leaving the foaming slurry to expand within the cavity of the construction or of the device.

The filling can be performed by any adapted way, such as injection of the foaming slurry within the cavity or depositing one or many layer(s) of foaming slurry into the cavity. A mobile robotic arm can be used to deposit layers of foaming slurry.

The invention also relates to the use of the construction whose at least one cavity has been filled by the method of the invention with mineral foam as building material. For example, the construction may be walls, floors, roofs on a worksite, window frames. It is also envisaged to produce elements prefabricated in a precast factory from the foam according to the invention such as blocks, panels. It is also envisaged to produce 3D printed constructions or elements, in particular 3D printed walls.

The invention also relates to the use of construction whose at least one cavity has been filled by the method of the invention with mineral foam for insulation, in particular for thermal or phonic insulation.

Advantageously, it is possible in certain cases to replace glass wool, asbestos or insulants made of polystyrene and polyurethane with the mineral foam of the invention.

Thus, the invention offers as other advantage that the mineral foam of the invention has excellent thermal properties, and notably a very low thermal conductivity. Reducing the thermal conductivity of building materials is highly desirable since it makes it possible to obtain a saving in heating energy in residential or working buildings. In addition, the mineral foam obtained with the method of the invention makes it possible to obtain good insulation performances over small thicknesses and thus to preserve the surfaces and habitable volumes. The thermal conductivity (also called lambda (λ)) is a physical quantity characterizing the behaviour of materials during the transfer of heat by conduction. The thermal conductivity represents the quantity of heat transferred per surface unit and per time unit under a temperature gradient. In the international units system, the thermal conductivity is expressed in watts per Kelvin meter, (W·m⁻¹·K⁻¹). Classical or traditional concretes have a thermal conductivity between 1.3 and 2.1 measured at 23° C. and 50% relative humidity.

The invention thus also refers to a method for insulating a device, in particular for thermal or phonic insulation, by filling at least one cavity of the device, especially by filling at least one cavity of the jacket in a jacketed device, with a low-density mineral foam comprising the following steps:
(i) preparing a cement slurry comprising:
   Portland cement;
   ultrafine particles of which the D50 is comprised from 10 to 600 nm;
   a water reducing agent;
   manganese salts; and
   water;
   wherein the mass ratio of manganese salts/Portland cement is below 0.014
(ii) adding to the cement slurry obtained after step (i) a gas-forming liquid comprising:
   a gas-forming agent; and
   a viscosity-modifying agent which is a polymer chosen among anionic bio-based polymer, amphiphilic bio-based polymer, alkali swellable acrylic polymer and mixture thereof;
to obtain a foaming slurry;
(iii) filling at least one cavity of the device with the foaming slurry obtained at step (ii);
(iv) leaving the foaming slurry to expand within the cavity of device.

The filling can be performed by any adapted way, such as injection of the foaming slurry within the cavity or depositing one or many layer(s) of foaming slurry into the cavity. A mobile robotic arm can be used to deposit layers of foaming slurry.

The device, the cement slurry, the gas-forming liquid, the foaming slurry and the method steps are such as disclosed above.

The mineral foam obtained with the method of the invention has a thermal conductivity comprised from 0.03 to 0.5 W/(m·K), preferably from 0.04 to 0.15 W/(m·K), more preferentially from 0.04 to 0.10 W/(m·K).

The invention has also the benefit of providing a mineral foam having good mechanical properties, and notably good compressive strength compared with known mineral foams. The mineral foam obtained with the method of the invention has a compressive strength comprised from 0.04 to 5 MPa after 28 days, preferably from 0.05 to 2 MPa after 28 days, more preferentially from 0.05 to 1 MPa after 28 days.

The construction according to the invention is advantageously capable of withstanding or reducing air and thermo-hydric transfers, that is to say that this element has a controlled permeability to transfers of air, of water in the form of vapour or liquid.

The device according to the invention is advantageously capable of withstanding or reducing air and thermo-hydric transfers, that is to say that this element has a controlled permeability to transfers of air, of water in the form of vapour or liquid.

### DETAILED DESCRIPTION OF EMBODIMENTS OF THE INVENTION

### Method for Measuring a Wetting or Contact Angle

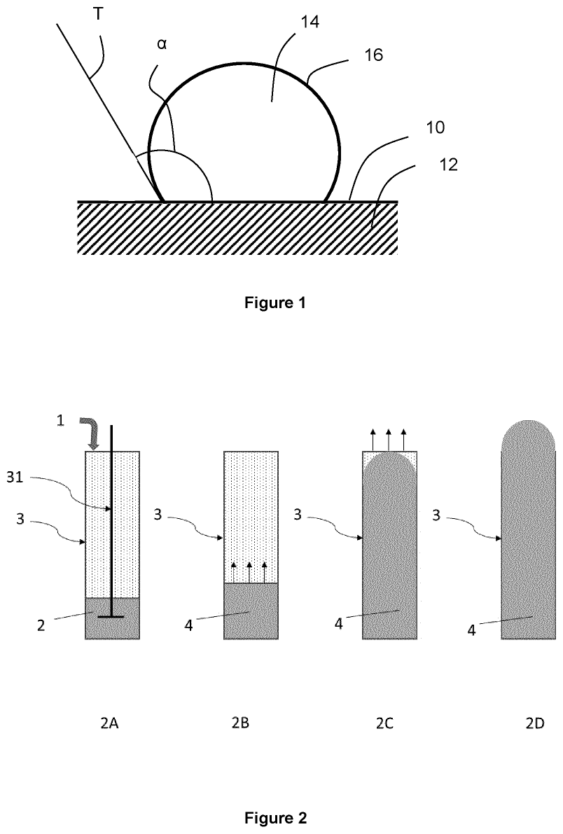

FIG. 1 illustrates the principle for measuring a wetting angle between a solid surface 10 of a sample 12 made of concrete and a drop 14 of a liquid deposited on the surface 10. The reference 16 designates the liquid/gas interface between the drop 14 and ambient air. FIG. 1 is a cross-section along a plane perpendicular to the surface 10. In the section plane, the wetting angle α corresponds to the angle, measured from the inside of the drop 14 of liquid, between the surface 10 and the tangent T to the interface 16 at the point of intersection between the solid 10 and the interface 16.

To carry out the measurement of the wetting angle, the sample 12 is placed in a room at a temperature of 20° C. and a relative humidity of 50%. A drop of water 14 having a volume of 2.5 μL is placed on the surface 10 of the sample 12. The angle measurement is carried out by an optical method, for example using a drop shape analysis device, for example the DSA 100 device commercialised by Krüss. The measurements are repeated five times and the value of the contact angle measured between the drop of water and the support is equal to the average of these five measurements.

### Method for Measuring the Particle Size Distribution

The particle size curves of the different powders are obtained from a Mastersizer 2000 (year 2008, series MAL1020429) type laser particle size analyser sold by the Malvern Company. The measurement is carried out in an appropriate medium (for example, in aqueous medium) in order to disperse the particles; the size of the particles must be comprised from 1 μm to 2 mm. The luminous source is constituted of a red He-Ne laser (632 nm) and a blue diode (466 nm). The optical model is that of Fraunhofer, the calculation matrix is of polydisperse type. A background noise measurement is firstly carried out with a pump speed of 2000 rpm, a stirrer speed of 800 rpm and a noise measurement over 10 s, in the absence of ultrasounds. It is then checked that the luminous intensity of the laser is at least equal to 80%, and that a decreasing exponential curve is obtained for the background noise. If this is not the case, the lenses of the cell have to be cleaned.

A first measurement is next carried out on the sample with the following parameters: pump speed of 2000 rpm, stirrer speed of 800 rpm, absence of ultrasounds, obscuration limit between 10 and 20%. The sample is introduced to have an obscuration slightly greater than 10%. After stabilisation of the obscuration, the measurement is carried out with a duration between the immersion and the measurement set at 10 s. The measurement is 30 s (30000 diffraction images analysed). In the granulogram obtained, it is necessary to take account of the fact that a part of the population of the powder may be agglomerated.

A second measurement is then carried out (without emptying the vessel) with ultrasounds. The pump speed is taken to 2500 rpm, the stirring to 1000 rpm, the ultrasounds are emitted at 100% (30 watts). This regime is maintained for 3 minutes, then the initial parameters are returned to: pump speed of 2000 rpm, stirrer speed of 800 rpm, absence of ultrasounds. At the end of 10 s (to evacuate potential air bubbles), a 30 s measurement (30000 images analysed) is carried out. This second measurement corresponds to a powder de-agglomerated by ultrasound dispersion.

Each measurement is repeated at least twice to check the stability of the result. The apparatus is calibrated before each working session by means of a standard sample (silica C10 Sifraco) of which the particle size curve is known. All the measurements presented in the description and the ranges announced correspond to the values obtained with ultrasounds.

### Method for Measuring the BLAINE Specific Surface Area

The specific surface of the different materials is measured as follows.

The Blaine method at 20° C. with a relative humidity not exceeding 65% using a Blaine Euromatest Sintco apparatus complying with the European standard EN 196-6.

Before the measurement of the specific surface, the wet samples are dried in an oven until a constant weight is obtained at a temperature from 50 to 150° C. (the dried product is next ground to obtain a powder of which the maximum size of the particles is less than or equal to 80 μm).

### Method for Measuring the Yield Stress of the Slurry

The rheology measurement of the cement slurry is done with a rheometer (Anton Paar RheolabQC) with a double-helix ribbon geometry after 30 minutes after the first contact between water and premix. The protocol used is:
pre-shearing at 50 s⁻¹
Ramp from 0.01 to 75 s⁻¹
Ramp from 75 to 0.01 s⁻¹.

The rheological measurement provides a curve giving the shear rate as a function of shear stress. The analysis of that curve enables to determine the yield stress: the yield stress corresponds to the Y-intercept of the linear part of the curve, wherein the linear part is typically in the range of 20 to 60 s⁻¹.

### Method for Measuring the Wet Density of the Foamed Slurry

The foamed slurry is poured in a cylinder 11×22 cm i.e. with a known volume. The density of the foamed slurry is the ratio between the mass of the foamed slurry to fill the cylinder and the volume of the cylinder. The weight foamed slurry is measured 1-5 minutes after the foaming.

### EXAMPLE 1: Preparation of the Cement Slurry

The cement slurry is prepared by mixing the components of the table 1 into the respective proportions given in the table.

TABLE 1

| Components | Formulation (wt. %*) |
|---|---|
| Premix** | 74.7 |
| Superplasticizer | 1.09 |
| MnCl₂ | to be adapted |
| Water | qsp 100 |

*the values are expressed as percentages in weight by total weight of cement slurry.
**the premix is composed of 77.6 wt. % of cement CEM I and 17.1 wt. % of mineral addition (ground limestone filler Betocarb supplied by Omya) and 5.3 wt. % of Socal312. The cement CEM I is an ultrafine cement having a Blaine Value of 7200 cm/g².

The cement slurry is mixed in double-walled tank (to keep the cement slurry temperature at 20° C.) with a bench agitator (Supertest VMI) with deflocculating blade according the following protocol:
Pouring the water in the tank and then adding and mixing (300 rpm) the superplasticizer and MnCl₂ until dissolution
Pouring slowly the premix powder into the tank during 15 minutes with an agitation speed of 900 rpm.

### EXAMPLE 2: Preparation of the Gas Forming Liquid

The gas forming liquid is prepared by mixing the components of the table 2 into the respective proportions given in the table.

TABLE 2

| Components | Formulation (wt. %)* |
|---|---|
| H₂O₂ | 7.90 |
| Amphiphilic polymer | 0.035 |
| (Walocel MKW 4000 PF | |
| produced by Dow) | |
| Water | 92.065 |

*the values are expressed as percentages in weight by total weight of gas forming liquid.

A solution of polymer at 1 wt. % is prepared and then mixed with a solution of H₂O₂ at 30 wt. %. Then, the water is poured and mixed manually.

### EXAMPLE 3: Foaming Slurry Expansion Time

A 11×22 cm (diameterxheight) cylinder is filled with 400 mL of slurry cement disclosed in example 1. The slurry is let under agitation at 1000 rpm. The gas forming liquid disclosed in example 2 is poured the cylinder in 3 seconds and then the agitation is stopped. The foaming slurry starts its expansion and finishes its expansion outside the cylinder.

To determine the foaming slurry expansion time the following method, as illustrated in FIG. 2, is implemented:
a chronometer is started after pouring of the gas forming liquid, once the agitation is stopped (FIG. 2B).
the foaming slurry starts its expansion: the expansion time (t1) is defined as the time for the foaming slurry to reach the top of the 11×22 cylinder (FIG. 2C).
the foaming slurry finishes its expansion outside the cylinder (t2). The expansion duration is the difference between t2 and t1 (FIG. 2D) 6 mineral foams (FT1, F1, F2, F3, F4 and FC) are prepared.

FT1 is a control mineral foam manufactured by mixing slurry cement disclosed in example 1 with 0 wt. % of MnCl₂ and the gas forming liquid disclosed in example 2.

FC is a comparative mineral foam manufactured by mixing slurry cement disclosed in example 1 with a ratio of MnCl2 to Portland Cement of 0.0145 and the gas forming liquid disclosed in example 2.

F1 is a mineral foam of the invention manufactured by mixing slurry cement disclosed in example 1 with a ratio of MnCl₂ to Portland Cement of 0.0025 and the gas forming liquid disclosed in example 2.

F2 is a mineral foam of the invention manufactured by mixing slurry cement disclosed in example 1 with a ratio of MnCl₂ to Portland Cement of 0.0055 and the gas forming liquid disclosed in example 2.

F3 is a mineral foam of the invention manufactured by mixing slurry cement disclosed in example 1 with a ratio of MnCl₂ to Portland Cement of 0.0085 and the gas forming liquid disclosed in example 2.

F4 is a mineral foam of the invention manufactured by mixing slurry cement disclosed in example 1 with a ratio of MnCl₂ to Portland Cement of 0.0115 and the gas forming liquid disclosed in example 2.

The foam expansion time and ability to fill a complex cavity is reported in the table below.

TABLE 3

| Mineral foam | FT | F1 | F2 | F3 | F4 | FC |
|---|---|---|---|---|---|---|
| MnCl₂/cement ratio | 0 | 0.0025 | 0.0055 | 0.0085 | 0.0115 | 0.0145 |
| Wet density (kg/m³) | 156 ± 10 | 141 ± 3 | 128 ± 2 | 123 ± 1 | 123 ± 2 | 124 ± 5 |
| Expansion time (s) | 183 ± 6 | 138 ± 4 | 61 ± 2 | 24 ± 1 | 14 ± 1 | 10 ± 1 |
| Expansion duration (s) | 196 ± 36 | 183 ± 22 | 192 ± 14 | 139 ± 9 | 100 ± 10 | 80 ± 11 |
| Ability to fill a complex | No | Yes: | Yes: Totally | Yes: Totally | Yes: | No |
| cavity | | Partially | | | Partially | |

### EXAMPLE 4: Ability to Fill Complex Cavity

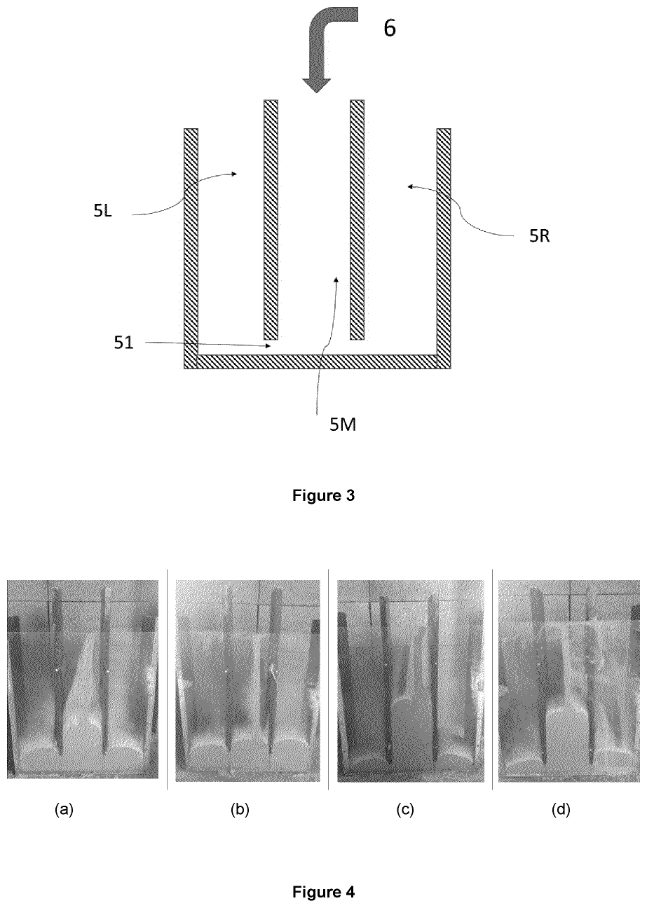

A prototype of a complex cavity is manufactured as illustrated in FIG. 3.

The prototype has a box-form, closed with a plexiglass allowing a visual assessing of the foaming slurry expansion. The box comprises three columns: left-column (5L), middle column (5M) and right-column (5R). The middle column is separated from the left and right columns by movable walls which can be opened (by lifting them) to allow the foaming slurry, poured in the middle column to reach the left and right columns. The gap width 51 can be changed to vary the complexity of the pouring.

The theoretical volume (i.e. the volume of each column when the movable walls are totally closed, the gap width is then equal to 0) of each column is 8L.

The middle column (5M) is poured with slurry cement disclosed in example 1 with a ratio of MnCl₂ to Portland Cement of 0.0085 (F3) or with a ratio of MnCl₂ to Portland Cement of 0.0145 (FC) and the gas forming liquid disclosed in example 2. The mass ratio of cement slurry to gas forming liquid is of 3.05.

The pouring is done in 4 s, corresponding to a volume of 8L of foamed slurry.

We measure the foamed slurry height in the left-column (5L), middle column (5M) and right-column (5R). Since the foamed slurry forms a meniscus in the cavity, we measure the minimal height and the maximal height of the meniscus.

Results are reported in the table below.

TABLE 4

| | | | | | | | | Total |
|---|---|---|---|---|---|---|---|---|
| | | | | | | | | weight of |
| | | | | | | | | foaming |
| | | Foam | | Foam | | Foam | | slurry |
| | | height— | | height— | | height— | | poured |
| | gap | left | | middle | | right | | into the |
| | width | column | | column | | column | | prototype |
| | 51 | Min | Max | Min | Max | Min | Max | (kg) |
| FC | 2 cm | 0 | 4.2 | 23.5 | 25 | 0 | 5 | 1 |
| F3 | 2 cm | 2.5 | 4.5 | 20 | 23.5 | 5.5 | 8.2 | 0.99 |
| FC | 6 cm | 5 | 8.5 | 15 | 18 | 4 | 9 | 0.96 |
| F3 | 6 cm | 6.5 | 9.5 | 10 | 12 | 9 | 12.5 | 1.03 |

The wet density (kg/m³) of the foamed slurry is also measured:

F3: 176 kg/m³

FC: 170 kg/m³

In this example, the wet densities of the mineral foams F3 and FC are higher than those measured in example 3. These differences are not significant and are the consequences of minor changes of the experimental conditions, such as the temperature of the foaming slurry while it is expanding. The wet density of foamed slurries and final mineral foams obtained from the reaction of a gas-forming liquid can vary around an average value.

Results are also presented in pictures in FIG. 4:

FIG. 4(a) shows the expansion achieved with the foam FC, with a space 51 (cf. FIG. 3) of 6 cm.

FIG. 4(b) shows the expansion achieved with the foam F3, with a space 51 (cf. FIG. 3) of 6 cm.

FIG. 4(c) shows the expansion achieved with the foam FC, with a space 51 (cf. FIG. 3) of 2 cm.

FIG. 4(d) shows the expansion achieved with the foam F3, with a space 51 (cf. FIG. 3) of 2 cm.

1. A method for the production of a cavity filled with a low-density mineral foam comprising the following steps:
(i) preparing a cement slurry comprising:
Portland cement;
ultrafine particles of which the D50 is comprised from 10 to 600 nm;
a water reducing agent;
a manganese salt; and
water;
wherein the mass ratio of manganese salts/Portland cement is below 0.014
(ii) adding to the cement slurry obtained after step (i) a gas-forming liquid comprising:
a gas-forming agent; and
a viscosity-modifying agent which is a polymer chosen among anionic bio-based polymer, amphiphilic bio-based polymer, alkali swellable acrylic polymer and mixture thereof;
to obtain a foaming slurry;
(iii) filling the cavity with the foaming slurry obtained at step (ii);
(iv) leaving the foaming slurry to expand within the cavity.

2. The method according to claim 1, wherein in the cement slurry the mass ratio of manganese salts/Portland cement is below 0.013.

3. The method according to claim 1, wherein the mineral foam has a density in the dry state from 50 to 180 kg/m³.

4. The method according to claim 1, wherein the cement of the mixture of step (i) is a CEM I cement.

5. The method according to claim 1, wherein the gas-forming agent comprised in the gas-forming liquid added in step (ii) is in a concentration of less than 15 wt. % of the weight of the gas-forming liquid.

6. The method according to claim 1, wherein the gas-forming agent comprised in the gas-forming liquid added in step (ii) is a solution of hydrogen peroxide, a solution of peroxomonosulphuric acid, a solution of peroxodisulfphuric acid, a solution of alkaline peroxides, a solution of alkaline earth peroxides, a solution of organic peroxide, a suspension of particles of aluminium or mixtures thereof.

7. The method according to claim 1, wherein the viscosity-modifying agent comprised in the gas-forming liquid added in step (ii) is an amphiphilic bio-based polymer.

8. The method according to claim 1, wherein the cement slurry of step (i) further comprises a mineral addition of which the particles have a D50 comprised from 0.1 μm to 4 mm.

9. The method according to claim 1, wherein the cement slurry of step (i) further comprises fibres.

10. The method according to claim 1, wherein the cement slurry of step (i) is obtained by first blending a premix of cement and ultrafine particles and then adding manganese salt and water.

11. The method according to claim 10, wherein the water reducing agent is in powder form and added to the premix or the water reducing agent is in liquid form and added to the water.

12. The method according to claim 1, wherein the cavity of step (iii) is a cavity in an element of a building or a construction.

13. A construction whose at least one cavity is filled by the method according to claim 1.

14. A method comprising utilizing the construction according to claim 13 as insulating material.

15. A method for insulating a device by filling at least one cavity of the device or of the jacket of the device with a low-density mineral foam by the method according to claim 1.

16. The method according to claim 2, wherein in the cement slurry the mass ratio of manganese salts/Portland cement is below 0.0125.

17. The method according to claim 3, wherein the mineral foam has a density in the dry state from 70 to 150 kg/m³.

18. The method according to claim 4, wherein the cement has a Blaine specific surface area above 5000 cm²/g.

19. The method according to claim 5, wherein the gas-forming agent concentration is less than 8 wt. % of the weight of the gas-forming liquid.

20. The method according to claim 7, wherein the viscosity-modifying agent is methyl cellulose, methylhydroxyethyl cellulose or hydroxypropylmethyl cellulose.
